(19) United States
(12) Patent Application Publication
(10) Pub. No.: US 2024/0336431 A1
(43) Pub. Date: Oct. 10, 2024

(54) CONTAINER AND CONTAINER RECOGNITION METHOD

(71) Applicant: HAI ROBOTICS CO., LTD., Shenzhen (CN)

(72) Inventors: Tongjuan SONG, Shenzhen (CN); Lang ZHOU, Shenzhen (CN); Zilong JING, Shenzhen (CN)

(21) Appl. No.: 18/747,633

(22) Filed: Jun. 19, 2024

Related U.S. Application Data
(63) Continuation of application No. PCT/CN2022/130981, filed on Nov. 9, 2022.

(30) Foreign Application Priority Data
Dec. 21, 2021 (CN) 202111576202.7

(51) Int. Cl. B65G 1/04; B65G 1/137

(52) U.S. Cl. CPC B65G 1/0485; B65G 1/1373

(57) ABSTRACT

Embodiments of the present disclosure provide a container, a container recognition method, apparatus, and device, a warehousing system, and a medium. The container includes a base plate, a side plate, and a container identification code attached to the side plate, where the base plate and the side plate form a compartment. The container identification code includes a first identification code and a second identification code, the first identification code is used for identifying the compartment of the container, and the second identification code is used for identifying an orientation of the container. The compartment is an independent space used for storing goods in the container, the compartment includes one or more storage units, and the storage unit is a minimum unit used for storing goods dividable by the container.

### CROSS-REFERENCES

This application is a continuation of International Patent Application No. PCT/CN2022/130981 filed on Nov. 9, 2022, which claims priority to Chinese Patent Application No. 202111576202.7, field with the China National Intellectual Property Administration on Dec. 21, 2021 and entitled “CONTAINER, CONTAINER RECOGNITION METHOD, APPARATUS, AND DEVICE, WAREHOUSING SYSTEM, AND MEDIUM”, which is incorporated herein by reference in its entirety.

### TECHNICAL FIELD

The present disclosure relates to the field of intelligent warehousing technologies, and in particular, to a container, a container recognition method, apparatus, and device, a warehousing system, and a medium.

### BACKGROUND OF THE INVENTION

A robot-based warehousing system uses an intelligent operating system to automatically retrieve and store goods through system instructions. In addition, the robot-based warehousing system can operate 24 hours a day without interruption, replacing manual management and operations, so that the warehousing efficiency is improved, and the robot-based warehousing system is widely applied and popular.

A container used by the warehousing system may be divided into a plurality of compartments according to a requirement, so that different goods can be stored in different compartments, to improve the space utilization and a storage capacity of the warehousing system. When the container is transported to a workstation or a work table through a conveyor, an operator generally cannot determine positions of the compartments, leading to low execution efficiency of a sorting task.

### SUMMARY OF THE INVENTION

The present disclosure provides a container, a container recognition method, apparatus, and device, a warehousing system, and a medium. By recognizing a container identification code arranged on a container, a position of each compartment of the container can be quickly determined, thereby improving the sorting efficiency.

According to a first aspect, an embodiment of the present disclosure provides a container, including a base plate, a side plate, and a container identification code attached to the side plate, where the base plate and the side plate form a compartment. The container identification code includes a first identification code and a second identification code, the first identification code is used for identifying the compartment of the container, and the second identification code is used for identifying an orientation of the container. The compartment is an independent space used for storing goods in the container, the compartment includes one or more storage units, and the storage unit is a minimum unit used for storing goods dividable by the container.

In some embodiments, the base plate and the side plate form at least two compartments, and the first identification code for identifying each of the at least two compartments is located on the side plate.

In some embodiments, there is at least one first identification code for identifying each of the at least two compartments.

In some embodiments, the first identification code is further used for identifying the container.

In some embodiments, the second identification code is further used for identifying the container.

In some embodiments, a quantity of first identification codes is a quantity of storage units in the container.

In some embodiments, a container opening configured for retrieving and storing goods is provided on the container, at least one first side of each compartment overlaps with at least part of a side of the container opening, the first identification code is arranged on at least two sides of the container opening, and the first identification code is mapped to a compartment to which a first side on which the first identification code is located belongs.

In some embodiments, the first identification code is arranged on two opposite second sides of the container opening, where each compartment has one side intersecting with one of the second sides.

In some embodiments, the base plate and the side plate form an inner cavity and a container opening; the first identification code includes a first part, a second part, and a third part; and the first part of the first identification code is arranged on a surface of the side plate facing away from the inner cavity, the second part is arranged at a top of the side plate, and the third part is arranged on a surface of the side plate facing the inner cavity.

In some embodiments, a text code is arranged on the first part and the third part; and when the first identification code is unfolded, the text code arranged on the first part and the text code arranged on the third part of the first identification code are symmetrical about a center of the first identification code.

In some embodiments, separating openings are provided on at least two opposite side surfaces of the container, and when a separating plate is inserted into the separating openings provided opposite to each other, a storage space of the container is separated to obtain a plurality of compartments.

In some embodiments, a first side surface and a second side surface of the container are equipped with a first quantity of separating openings, a third side surface and a fourth side surface of the container are equipped with a second quantity of separating openings, the first side surface is opposite to the second side surface, the third side surface is opposite to the fourth side surface, and the first quantity is less than or equal to the second quantity.

In some embodiments, the second identification code is arranged on at least two side surfaces of the container.

In some embodiments, each side surface of the container is provided with one second identification code, and the second identification code on the first side surface is arranged opposite to the second identification code on the second side surface; and an arrangement position of the second identification code on the third side surface and an arrangement position of the second identification code on the fourth side surface are symmetrical about a center point of the container.

In some embodiments, second identification codes arranged on the two opposite side surfaces of the container corresponds to the opposite orientations of the container.

In some embodiments, the container further includes a third identification code, where the third identification code includes a preset identification pattern, and a robot is configured to determine a pose relationship between the robot and the container on which the third identification code is arranged by recognizing the preset identification pattern of the third identification code.

According to a second aspect, an embodiment of the present disclosure further provides a container recognition method, including:
obtaining a recognition result of a second identification code arranged on a specified surface of a container, where the container is the container according to any embodiment corresponding to the first aspect of the present disclosure, and the specified surface is any surface of the container on which the second identification code is arranged; determining a position of each compartment of the container according to the recognition result; and generating a sorting indication according to the position of each compartment.

Optionally, the determining the position of each compartment of the container according to the recognition result includes:
obtaining a first attribute of the container, where the first attribute is used for describing a quantity of compartments corresponding to the container; determining a current pose of the container according to the recognition result; and determining the position of each compartment of the container according to the current pose of the container and the first attribute.

Optionally, the determining the position of each compartment of the container according to the recognition result includes:
obtaining a second attribute of the container, where the second attribute is used for describing a storage unit corresponding to each compartment of the container; determining a position of each storage unit of the container based on a first correspondence when orientation information of the container in the recognition result is first orientation information, or determining a position of each storage unit of the container based on a second correspondence when orientation information of the container in the recognition result is second orientation information; and determining the position of each compartment of the container according to the second attribute and the position of each storage unit, where the first correspondence is used for describing the position of each storage unit of the container when the container is under a first orientation or the orientation information is the first orientation information, and the second correspondence is used for describing the position of each storage unit of the container when the container is under a second orientation or the orientation information is the second orientation information.

Optionally, the method further includes:
determining one or more target compartments according to a sorting task and storage information of each compartment of the container, where the storage information of each compartment includes goods and a quantity of the goods stored in the compartment.

Optionally, the method further includes:
obtaining a first identification code corresponding to the target compartment, to obtain compartment identification information and container recognition information corresponding to the target compartment; and performing verification on the target compartment according to the compartment identification information and the container recognition information corresponding to the target compartment.

According to a third aspect, an embodiment of the present disclosure further provides a container recognition apparatus, including:
a recognition module, configured to recognize a second identification code arranged on a specified surface of a container, where the container is the container according to any embodiment corresponding to the first aspect of the present disclosure, and the specified surface is any surface of the container on which the second identification code is arranged; a position determining module, configured to determine a position of each compartment of the container according to a recognition result; and an instruction generation module, configured to generate a sorting indication according to the position of each compartment.

According to a fourth aspect, an embodiment of the present disclosure further provides a container recognition device, including a memory and at least one processor, where the memory stores computer-executable instructions; and the at least one processor executes the computer-executable instructions stored in the memory, to cause the at least one processor to perform the container recognition method according to any embodiment corresponding to the second aspect of the present disclosure.

According to a fifth aspect, an embodiment of the present disclosure further provides a warehousing system, including the container according to any embodiment corresponding to the first aspect of the present disclosure and the container recognition device according to the embodiment corresponding to the fourth aspect of the present disclosure.

According to a sixth aspect, an embodiment of the present disclosure further provides a computer-readable storage medium, the computer-readable storage medium storing computer-executable instructions, where when a processor executes the computer-executable instructions, the container recognition method according to any embodiment corresponding to the second aspect of the present disclosure is performed.

According to a seventh aspect, an embodiment of the present disclosure further provides a computer program product, including a computer program, where when a processor executes the computer program, the container recognition method according to any embodiment corresponding to the second aspect of the present disclosure is performed.

According to the container, the container recognition method, apparatus, and device, the warehousing system, and the medium provided in the embodiments of the present disclosure, a container identification code including a first identification code and a second identification code is arranged on a container, where the first identification code is used for identifying a compartment of the container, and the second identification code is used for identifying an orientation of the container, so that the orientation of the container and a position of each compartment of the container can be quickly determined based on the first identification code and the second identification code during sorting, thereby helping sort goods stored in a specified compartment, simplifying a procedure that an operator recognizes a compartment, and improving the processing efficiency of sorting.

### BRIEF DESCRIPTION OF DRAWINGS

The accompanying drawings herein are incorporated in and constitute a part of the specification, illustrate embodiments of the present disclosure, and are used to explain the principle of the present disclosure together with the specification.

FIG. 1 is a diagram of an application scenario of a container recognition method according to an embodiment of the present disclosure;

FIG. 2 is a schematic structural diagram of a container according to an embodiment of the present disclosure;

FIG. 3 is a schematic diagram of an identification code in the embodiment shown in FIG. 2 of the present disclosure;

FIG. 4 is a schematic structural diagram of a container according to another embodiment of the present disclosure;

FIG. 5 is a schematic structural diagram of a container according to another embodiment of the present disclosure;

FIG. 6 is a schematic diagram when a first identification code provided in the embodiment shown in FIG. 5 is unfolded of the present disclosure;

FIG. 7 is a schematic structural diagram of a container according to another

embodiment of the present disclosure;

FIG. 8 is a schematic diagram of an arrangement position of an identification code of the container provided in the embodiment shown in FIG. 7 of the present disclosure;

FIG. 9 is a schematic structural diagram of a container according to another embodiment of the present disclosure;

FIG. 10 is a flowchart of a container recognition method according to an embodiment of the present disclosure;

FIG. 11 is a flowchart of step S302 in the embodiment shown in FIG. 10 of the present disclosure;

FIG. 12 is a schematic diagram of relative positions of a container and a recognizer in the embodiment shown in FIG. 11 of the present disclosure;

FIG. 13 is a flowchart of a container recognition method according to another embodiment of the present disclosure;

FIG. 14 is a schematic structural diagram of a sorting workstation in the embodiment shown in FIG. 13 of the present disclosure;

FIG. 15 is a schematic structural diagram of a container recognition apparatus according to an embodiment of the present disclosure;

FIG. 16 is a schematic structural diagram of a container recognition device according to an embodiment of the present disclosure; and

FIG. 17 is a schematic structural diagram of a warehousing system according to an embodiment of the present disclosure.

The foregoing accompanying drawings illustrate specific embodiments of the present disclosure, and more detailed description is provided below. The accompanying drawings and literal description are not intended to limit the scope of the idea of the present disclosure in any manner, but explain the concept of the present disclosure by referring to specific embodiments for a person skilled in the art.

### DETAILED DESCRIPTION

Exemplary embodiments are described in detail herein, and examples of the exemplary embodiments are shown in the accompanying drawings. When the following description involves the accompanying drawings, unless otherwise indicated, the same numerals in different accompanying drawings represent the same or similar elements. The implementations described in the following exemplary embodiments do not represent all the implementations consistent with the present disclosure, but are instead only examples of apparatuses and methods that are described in detail in the appended claims and that are consistent with some aspects of the present disclosure.

The technical solutions of the present disclosure and how the foregoing technical problem is resolved in the technical solutions of the present disclosure are described below in detail by using specific embodiments. The following several specific embodiments may be combined with each other. Details of same or similar concepts or processes may not be described in some embodiments. The following describes the embodiments of the present disclosure with reference to the accompanying drawings.

The following explains an application scenario of the embodiments of the present disclosure:

FIG. 1 is a diagram of an application scenario of a container recognition method according to an embodiment of the present disclosure. As shown in FIG. 1, the container recognition method provided in this embodiment of the present disclosure may be performed by a container recognition device. To improve the utilization of a container storage space, a storage space of a container 10 may be divided into a plurality of compartments 11 according to a requirement. In FIG. 1, four compartments are used as an example, and each compartment 11 is an independent physical space, so that same or different SKUs (Stock Keeping Units, inventory unit) or goods of the same or different types are placed in different compartments 11 of the container 10.

When the container 10 loaded with a plurality of SKUs is transported to a work table 20 for sorting, because an orientation of the container 10 may be changed during a transportation process of the container 10, an operator 30 cannot know an orientation of the container 10 on the work table 20 and further cannot determine goods stored in each compartment 11. In this case, the operator needs to recognize a compartment 11 that needs to be sorted by scanning goods in the compartment 11 for a plurality of times, and the process of recognizing the compartment of the container 10 consumes a lot of time. As a result, the execution efficiency of a sorting task is low, and requirements of customers cannot be met.

To improve the recognition efficiency of the compartment 11 of the container 10, the present disclosure provides a container on which a first identification code and a second identification code are arranged and a recognition method for the container. By recognizing the second identification code, an orientation of the container is quickly determined, and by recognizing the first identification code, verification is performed on each compartment, thereby improving the recognition efficiency and accuracy of the compartment and further improving the execution efficiency of the sorting task.

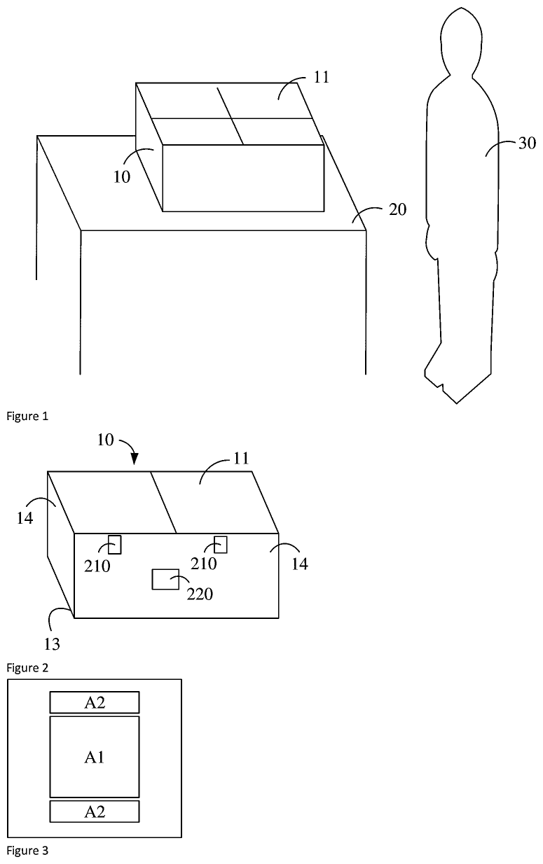

FIG. 2 is a schematic structural diagram of a container according to an embodiment of the present disclosure. As shown in FIG. 2, the container 10 includes a base plate 13, a side plate 14, and a container identification code attached to the side plate 14, where the base plate and the side plate form a compartment 11, and the container identification code includes a first identification code 210 and a second identification code 220.

The compartment 11 is an independent space used for storing goods in the container 10, the compartment 11 may include one or more storage units, and the storage unit is a minimum unit used for storing goods dividable by the container 10. The first identification code 210 is used for recognizing the compartment 11 of the container 10, and the second identification code 220 is used for recognizing an orientation of the container 10.

Specifically, the first identification code 210 includes compartment identification information of the corresponding compartment 11 to recognize the compartment 11; and the second identification code 220 includes orientation information of the container 10 to recognize the orientation of the container 10.

In some embodiments, the base plate 13 and the side plate 14 form at least two compartments 11 such as two, four, or eight compartments, and an example in which two compartments are formed is used in FIG. 2.

In some embodiments, the minimum quantity of the first identification code 210 for identifying each of the at least two compartments 11 is at least 1, such as 1, 2, 4, etc.

In some embodiments, one compartment 11 may correspond to at least one first identification code 210, that is, one compartment 11 may correspond to one or more first identification codes 210 to recognize the compartment 11.

In some embodiments, the first identification code 210 may be further used for recognizing the container 10.

In some embodiments, the second identification code 220 may be further used for recognizing the container 10.

In some embodiments, the first identification code 210 may include container recognition information of the container 10 and the compartment identification information of the corresponding compartment 11, and the second identification code 220 may include the container recognition information of the container 10 and the orientation information of the container 10, where the container recognition information may be a unique identification code of the container 10 for recognizing the container 10.

In some embodiments, each of the first identification code 210 and the second identification code 220 may be made of one or more of a one-dimensional barcode, a two-dimensional barcode, a barcode, a code, text, or a pattern.

For example, both the first identification code 210 and the second identification code 220 may be formed by a one-dimensional barcode and a code.

For example, FIG. 3 is a schematic diagram of an identification code in the embodiment shown in FIG. 2 of the present disclosure. The identification code may be the first identification code 210 or the second identification code 220. As shown in FIG. 3, the identification code includes a barcode symbol area A1 and an ASC II character string area A2, where a corresponding barcode is arranged in the barcode symbol area A1, and a corresponding code is arranged in the ASC II character string area A2.

In some embodiments, the first identification code 210 and the second identification code 220 may be encoded by using the code 128 encoding rule.

In some embodiments, the first identification code 210 may be formed by three parts: a preset control character, the container recognition information, and the compartment identification information sequentially; and the second identification code 220 may be formed by three parts: the preset control character, the container recognition information, and the orientation information sequentially.

For example, the preset control character may be LX, which is used for representing the container. The container recognition information may be identified by using six digits, and the compartment identification information may be represented by using one letter. For example, the compartment identification information may be represented by using eight letters A to H, which are respectively used for identifying a compartment A to a compartment H. The orientation information may also be represented by using one letter such as Q and R, where Q and R represent two different orientations of the container, and the two orientations are opposite to each other. For example, a first identification code 210 corresponding to a compartment A of a first container may be LX000001A, and encoding of a second identification code 220 arranged on a surface of a third container may be LX000003Q.

In some embodiments, a quantity of first identification codes 210 is a quantity of storage units in the container. In this way, no matter which segmentation manner is used to divide the storage space of the container, at least one first identification code 210 corresponds to one compartment 11, so that each compartment 11 of the container 10 is identified based on each first identification code 210.

In some embodiments, the second identification code 220 may be arranged on at least two side surfaces of the container 10.

For example, the second identification code 220 may be arranged on two opposite side surfaces of the container 10, or may be arranged on two adjacent side surfaces of the container 10, or may be arranged on three side surfaces of the container 10, or may be arranged on each side surface of the container 10.

In some embodiments, there may be one or more second identification codes 220 arranged on a side surface on which the second identification code 220 is arranged.

In some embodiments, orientations of the container 10 corresponding to second identification codes 220 arranged on opposite side surfaces of the container 10 are opposite to each other.

In some embodiments, the first identification code 210 of the container 10 may be in a one-to-one correspondence with the storage unit.

For example, a quantity of storage units may be 4, 8, 12, or another value, and a specific value may be determined according to factors such as a size of the container 10, sizes of goods stored in a warehousing system, and a requirement of a to-be-processed task.

The storage unit mentioned in the present disclosure is a minimum storage space obtained by dividing the container through a separating plate.

In some embodiments, a quantity and sizes of compartments 11 of the container 10 may be adjusted according to a requirement.

In some embodiments, each compartment 11 of the container 10 has the same size.

For example, each compartment 11 of the container 10 may be made of two storage units.

In some embodiments, each compartment 11 of the container 10 may have a different size.

For example, a compartment A of the container 10 may be made of two storage units, and a compartment B may be made of six storage units.

In this embodiment, a container identification code including a first identification code and a second identification code is arranged on a container, where the first identification code is used for identifying a compartment of the container, and the second identification code is used for identifying an orientation of the container, so that the orientation of the container and a position of each compartment of the container can be quickly determined based on the first identification code and the second identification code during sorting, thereby helping sort goods stored in a specified compartment, simplifying a procedure that an operator recognizes a compartment, and improving the processing efficiency of sorting.

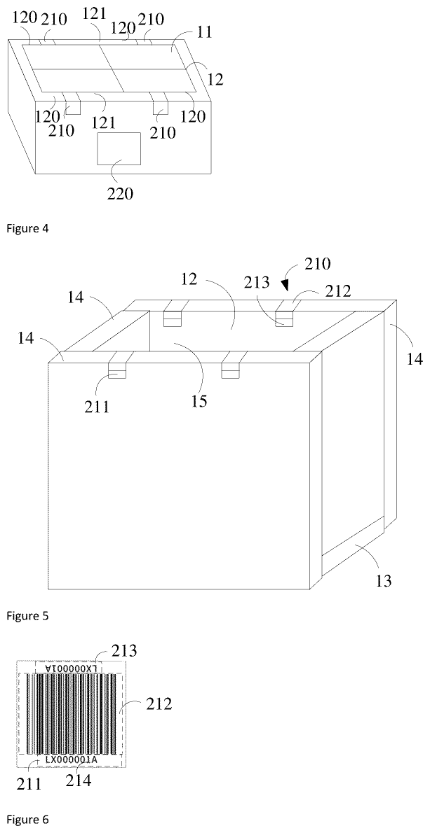

FIG. 4 is a schematic structural diagram of a container according to another embodiment of the present disclosure. Referring to FIG. 2 and FIG. 4, a container opening 12 configured for retrieving and storing goods is provided on the container 10, at least one first side 120 of each compartment 11 overlaps with at least part of a side of the container opening 12, and four compartments are provided as an example in FIG. 4.

Specifically, the first identification code 210 may be arranged on a first side 120 of the compartment 11, to recognize the compartment 11 on which the first identification code is arranged.

Specifically, the first identification code 210 may be arranged on at least two sides of the container opening 12, and the first identification code 210 is mapped to a compartment 11 to which a first side 120 on which the first identification code is located belongs. In FIG. 4, an example in which the first identification code 210 is arranged on two opposite sides of the container opening 12 is used, each first identification code 210 is mapped to one compartment 11.

In some embodiments, the first identification code 210 may be arranged on two adjacent sides of the container opening 12.

In some embodiments, a plurality of first identification code 210 may be mapped to the same compartment 11.

For example, an example in which the container opening 12 is in a shape of a rectangle is used, and four first identification codes 210 are uniformly arranged on both sets of long sides of the container opening 12 respectively. If the container 10 is divided into “cross-shaped” four compartments 11 shown in FIG. 4, two first identification codes 210 are arranged on a first side 120 of each compartment 11, and the two first identification codes 210 correspond to the compartment to which the first side 120 on which the two first identification codes 210 are arranged belongs. If the container 10 includes only one compartment, that is, division is not performed on the storage space of the container, all the first identification codes 210 arranged on the container opening 12 are mapped to the compartment.

In some embodiments, the first identification code 210 may be arranged on two opposite second sides 121 of the container opening 12, where each compartment 11 has one first side 120 intersecting with one of the second sides 121.

Specifically, no matter which manner is used to segment the storage space of the container, each obtained compartment has at least one first side 120 intersecting with one of the second sides 121.

In this embodiment, the first identification code 210 is arranged on the first side 120 of the corresponding compartment 11 intersecting with the container opening 12, so that the convenience of scanning the first identification code 210 is improved.

FIG. 5 is a schematic structural diagram of a container according to another embodiment of the present disclosure. Referring to FIG. 2 and FIG. 5, the base plate 13 and the side plate 14 of the container 10 form an inner cavity 15 and a container opening 12, and goods may be stored in the inner cavity 15 through the container opening 12, or goods in the inner cavity 15 may be retrieved through the container opening 12. The first identification code 210 may be folded and arranged on a side of the container opening 12, so that an operator can recognize the first identification code 210 arranged on the container 10 from various angles.

Specifically, the first identification code 210 is arranged on two opposite side plates 14.

Specifically, the first identification code 210 may include a first part 211, a second part 212, and a third part 213, where the first part 211 of the first identification code 210 is arranged on a surface of the side plate 14 facing away from the inner cavity 15, the second part 212 is arranged at a top of the side plate 14, and the third part 213 is arranged on a side of the side plate 14 facing the inner cavity 15.

In some embodiments, the first part 211, the second part 212, and the third part 213 of the same first identification code 210 are continuous.

In some embodiments, a gap may exist among the first part 211, the second part 212, and the third part 213 of the same first identification code 210.

In some embodiments, the first part 211 and the third part 213 of the same first identification code 210 are arranged opposite to each other and have the same size.

In some embodiments, each of the first part 211, the second part 212, and the third part 213 includes a recognizable identification code such as a one-dimensional barcode, so that the operator can conveniently scan the first identification code at various positions to recognize the compartment 11.

In some embodiments, a text code 214 is arranged on the first part 211 and the third part 213; and when the first identification code 210 is unfolded, the text code 214 arranged on the first part 211 and the text code 214 arranged on the third part 213 of the first identification code 210 are symmetrical about a center of the first identification code 210. Therefore, when the operator views the first identification code on the side plate 14 on which the first identification code 210 is arranged from two sides of the side plate, directions of the text codes 214 on the seen first identification code 210 both conform to a reading habit of the operator, so that the text code 214 on the first identification code 210 can be learned quickly.

In some embodiments, compartment identification information in the text code 214 corresponding to the first identification code 210 may be encoded in a clockwise or counterclockwise direction.

For example, FIG. 6 is a schematic diagram when a first identification code provided in the embodiment shown in FIG. 5 is unfolded according to the present disclosure. As shown in FIG. 6, the text code 214 of the first identification code 210 is “LX000001A”, which is respectively arranged on the first part 211 and the third part 213, the text code 214 on the first part 211 and the text code on the third part 213 have different orientations and form a symmetrical pattern about the center of the first identification code, and the barcode of the first identification code 210 is arranged on the second part 212.

In some embodiments, the first identification code 210 may be folded and arranged on a side of the container opening 12 to wrap a side on which the first identification code is located, so that the second part 212 of the first identification code 210 is folded into three surfaces, so that the operator can recognize the barcode on the second part 212 of the first identification code from various angles.

FIG. 7 is a schematic structural diagram of a container according to another embodiment of the present disclosure. Referring to FIG. 5 and FIG. 7, separating openings 141 (represented by using dashed boxes) are provided on opposite side surfaces (or side plates 14) of the container 10, and when a separating plate 142 is inserted into the separating openings 141 provided opposite to each other, the storage space of the container 10 may be divided to obtain a plurality of compartments 11.

In some embodiments, the separating openings 141 may only be provided on one group of opposite side surfaces, to segment the storage space of the container 10 in a direction corresponding to the opposite side surfaces. For example, the storage space is segmented into three independent spaces, namely, three compartments.

Specifically, a quantity of the separating openings 141 can decide a maximum quantity of compartments 11, namely, a quantity of storage units. A position at which the separating plate 142 is inserted decides the quantity of the compartments 11 of the container. That is, the quantity of the compartments may be adjusted and changed between one and the maximum quantity depending on positions and a quantity of inserted separating plates 142.

In some embodiments, the separating openings 141 may be provided on each side surface of the container 10, and separating openings 141 on two opposite side surfaces are provided opposite to each other, so that the storage space of the container 10 is segmented in two directions to obtain more storage units. In FIG. 7, an example in which the separating openings 141 are provided on each side surface is used.

In some embodiments, a quantity of separating openings 141 provided on a first side surface and a second side surface opposite to the first side surface is less than or equal to a quantity of separating openings 141 provided on a third side surface and a fourth side surface opposite to the third side surface. The two second sides 121 are respectively a side of the third side surface intersecting with the container opening 12 and a side of the fourth side surface intersecting with the container opening 12.

In some embodiments, a first quantity of separating openings 141 are respectively provided on a first side surface and a second side surface of the container 10, a second quantity of separating openings 141 are respectively provided on a third side surface and a fourth side surface of the container 10, the first side surface is opposite to the second side surface, the third side surface is opposite to the fourth side surface, and the first quantity is less than or equal to the second quantity.

For example, one separating opening 141 may be respectively provided on the first side surface and the second side surface, and three separating openings 141 may be respectively provided on the third side surface and the fourth side surface, so that when a separating plate 142 is inserted into the separating openings 141 provided opposite to each other, the container 10 may be segmented into eight compartments 11.

In some embodiments, each separating opening 141 is formed by two through holes, each through hole may be in a shape of a strip such as a rectangle or a rounded rectangle, so that the storage space of the container 10 can be segmented in two different directions.

In some embodiments, the container 10 is generally in a shape of a cuboid, namely, the container opening 12 is in a shape of a rectangle, and the second sides 121 may be long sides of the container opening 12. The first side surface and the second side surface are side surfaces on which short sides of the container opening 12 are located, and the third side surface and the fourth side surface are side surfaces on which the long sides of the container opening 12 are located.

In some embodiments, one second identification code 220 is arranged on each side surface (or side plate 14) of the container 10, the second identification code 220 on the first side surface and the second identification code 220 on the second side surface are arranged opposite to each other, and an arrangement position of the second identification code 220 on the third side surface and an arrangement position of the second identification code 220 on the fourth side surface are symmetrical about a center point of the container 10. Because the container 10 is generally in a shape of a cuboid, by using the foregoing arrangement manner, after the second identification code 220 is adhered to the third side surface, the operator or a mechanical arm can adhere the second identification code 220 to the fourth side surface at an original position by directly rotating the container 10 by 180 degrees without moving or adjusting a position, thereby improving a convenience degree and efficiency of adhering the second identification code 220.

For example, FIG. 8 is a schematic diagram of an arrangement position of an identification code of the container provided in the embodiment shown in FIG. 7 of the present disclosure. As shown in FIG. 8, the container 10 can be at most divided into eight compartments. That is, when the container is divided into 8 compartments, each compartment is a minimum dividable independent space, namely, there are eight storage units which are respectively represented by using letters A to H. Arrangement centers of the second identification codes 220 arranged on the first side surface S1 and the second side surface S2 are respectively a center of the first side surface S1 and a center of the second side surface S2, the arrangement position of the second identification code 220 arranged on the third side surface S3 and the arrangement position of the second identification code 220 arranged on the fourth side surface S4 are symmetrical about the center point O of the container 10, and a height of the arrangement position of the second identification code 220 arranged on the third side surface S3 and a center of the third side surface S3 may be located on the same horizontal line. In FIG. 8, Q or R is used to identify the second identification code 220, where orientations of the container 10 corresponding to second identification codes 220 corresponding to Q and R are opposite to each other, Q may represent that the orientation of the container 10 is a first orientation such as a positive direction, R may represent that the orientation of the container 10 is a second orientation such as a negative direction, and the first orientation is opposite to the second orientation.

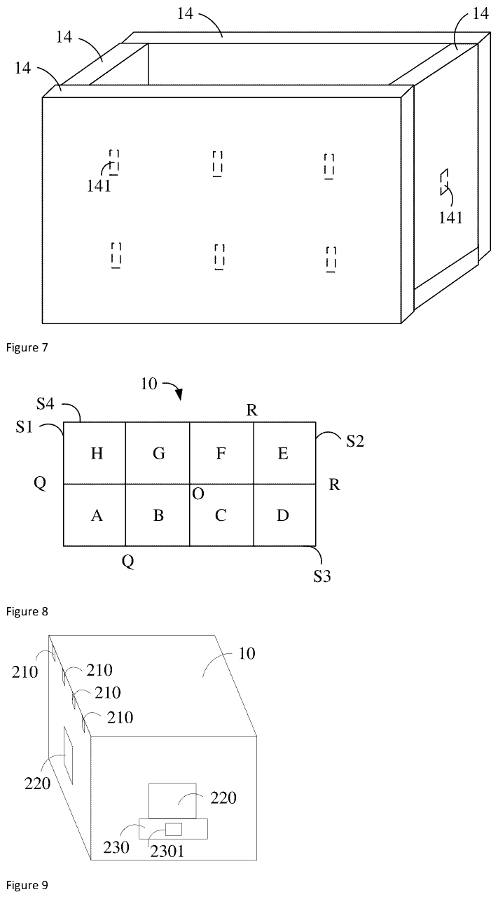

FIG. 9 is a schematic structural diagram of a container according to another embodiment of the present disclosure. As shown in FIG. 9, the container 10 further includes a third identification code 230. The third identification code 230 may be arranged on any one or more side surfaces of the container 10, and the third identification code 230 includes a preset identification pattern 2301, so that a robot can determine a pose relationship between the robot and the container 10 on which the third identification code 230 is arranged by recognizing the preset identification pattern 2301 on the third identification code 230, to implement alignment between the robot and the container 10, so as to perform a goods retrieval or storage operation on the container 10 safely.

In some embodiments, the preset identification pattern 2301 may be a two-dimensional barcode.

In some embodiments, the third identification code 230 may be arranged on two opposite side surfaces, and one of the side surfaces on which the third identification code 230 is arranged is a side surface of an end of the container 10 facing the robot when the container is placed on a rack, such as the first side surface and the second side surface.

In some embodiments, the identification codes including the first identification code 210, the second identification code 220, and the third identification code 230 are placed as centrally as possible to facilitate scanning and recognition.

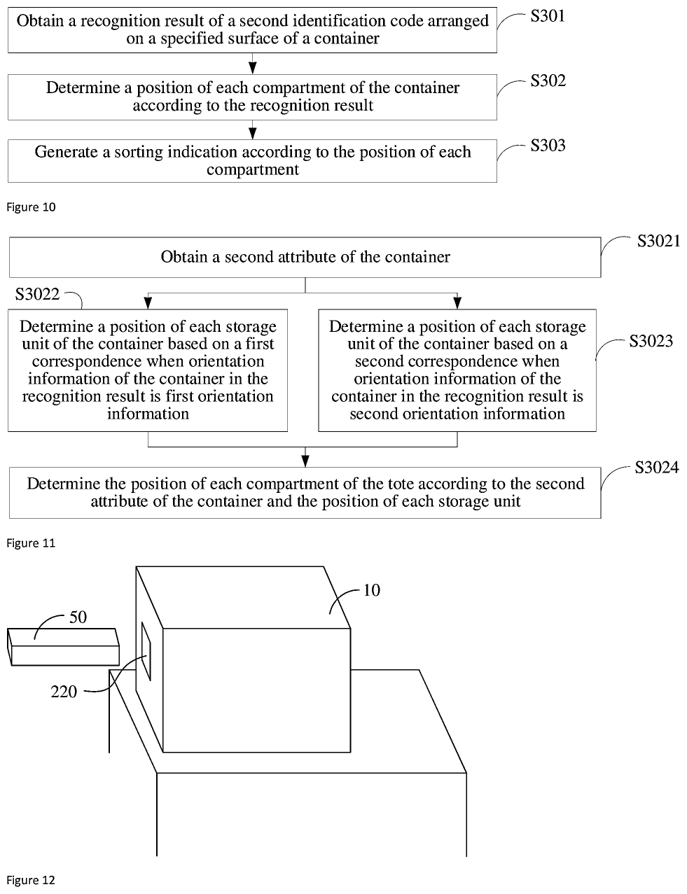

FIG. 10 is a flowchart of a container recognition method according to an embodiment of the present disclosure. The container recognition method may be performed by a container recognition device. As shown in FIG. 10, the container recognition method provided in this embodiment includes the following steps:

Step S301: obtaining a recognition result of a second identification code arranged on a specified surface of a container.

The container is the container 10 provided in any of the foregoing embodiments, and the specified surface is any surface such as any side surface of the container on which the second identification code is arranged. Four side surfaces of the container are respectively named a first side surface, a second side surface, a third side surface, and a fourth side surface, where the first side surface is opposite to the second side surface, and the third side surface is opposite to the fourth side surface.

In some embodiments, the container may be in a shape of a cuboid, namely, the container opening includes long sides and short sides, and the specified surface may be one of side surfaces on which the short sides of the container are located or one of side surfaces on which the long sides of the container are located.

Specifically, the recognition result of the second identification code arranged on the specified surface of the container may be recognized by a recognizer, and the recognizer further reports the recognition result to the container recognition device.

In some embodiments, the container may be transported to a work table through a conveyor, and when the container is transported to a recognition area of the recognizer, the recognizer recognizes the second identification code on the specified surface of the container on the conveyor to obtain the recognition result.

Step S302: determining a position of each compartment of the container according to the recognition result.

Specifically, the container recognition device may determine an orientation of the container based on the recognition result and further determine the position of each compartment of the container based on the orientation of the container.

In some embodiments, compartment identification information of compartments of each container is encoded sequentially according to a specific sequence such as a clockwise or counterclockwise sequence, and after the orientation of the container is determined, the position of each compartment of the container may be determined according to the orientation of the container and a quantity of compartments obtained by dividing the container.

For example, an example in which the container opening is in a shape of a rectangle is used. During compartment division, the container may be divided into four equal parts along the long side and divided into two equal parts along the short side to obtain eight compartments, where the eight compartments are distributed in two rows and each row includes four compartments, and each compartment corresponds to one compartment code. For example, codes of the compartments are sequentially A to H in a counterclockwise direction. Because the container opening includes one long side and one short side, assuming that a transportation direction of the container is a direction in which the long side is located and the side surfaces on which the two short sides are located are respectively the first side surface and the second side surface, during transportation through a robot or a robot and a conveyor, the first side surface of the container may be located in front of the second side surface in the transportation direction, or the second side surface is located in front of the first side surface in the transportation direction, so that the container has two opposite orientations. When the transportation direction is a direction in which the short side is located, the container also has two opposite orientations, so that after the orientation of the container is determined, the position of each compartment may be determined based on the orientation.

When the container is in a shape of a cube, namely, when the container opening is a square, recognition results of second identification codes arranged on two adjacent side surfaces or specified surfaces of the container may be obtained, and the position of each compartment of the container may be further determined based on the recognition results of the second identification codes arranged on the two adjacent side surfaces or specified surfaces. Specifically, the orientation of the container is determined based on the recognition results of the second identification codes arranged on the two adjacent side surfaces or specified surfaces; and the position of each compartment of the container is determined based on the orientation of the container.

Optionally, FIG. 11 is a flowchart of step S302 in the embodiment shown in FIG. 10 according to the present disclosure. As shown in FIG. 11, step S302 may include the following steps:

Step S3021: obtaining a second attribute of the container.

The second attribute is used for describing a storage unit corresponding to each compartment of the container.

In some embodiments, when compartment division is performed on the container, the storage space of the container may be equally divided into a plurality of compartments, that is, spatial sizes of the compartments obtained through division are the same, and quantities of storage units corresponding to the compartments are also the same.

In some embodiments, when compartment division is performed on the container, the container may not be equally divided, that is, the compartments of the container may be divided as independent spaces having different spatial sizes, and quantities of storage units corresponding to different compartments may also be different.

For example, an example in which the container includes four storage units is used, if the storage space of the container is divided into two compartments, one compartment may correspond to one storage unit, and the other compartment corresponds to the remaining three storage units.

Specifically, after the container is divided into a plurality of compartments, the second attribute of the container may be set according to the storage unit corresponding to each compartment.

Step S3022: determining a position of each storage unit of the container based on a first correspondence when orientation information of the container in the recognition result is first orientation information.

The first correspondence is used for describing the position of each storage unit of the container when the container is under a first orientation or the orientation information is the first orientation information.

Step S3023: determining a position of each storage unit of the container based on a second correspondence when orientation information of the container in the recognition result is second orientation information.

The second correspondence is used for describing the position of each storage unit of the container when the container is under a second orientation or the orientation information is the second orientation information.

In some embodiments, when the orientation information is the first orientation information, the orientation of the container is the first orientation, for example, the first side surface of the container is located in front of the second side surface in the transportation direction; and when the orientation information is the second orientation information, the orientation of the container is the second orientation, for example, the second side surface is located in front of the first side surface in the transportation direction.

In some embodiments, an arrangement position of the recognizer is fixed, an orientation corresponding to orientation information of a second identification code arranged on a specified surface of the container facing the recognizer is the orientation of the container. That is, when the orientation corresponding to the orientation information of the second identification code arranged on the specified surface is the first orientation, the orientation of the container is the first orientation, and when the orientation corresponding to the orientation information of the second identification code arranged on the specified surface is the second orientation, the orientation of the container is the second orientation.

For example, FIG. 12 is a schematic diagram of relative positions of a container and a recognizer in the embodiment shown in FIG. 11 of the present disclosure. As shown in FIG. 12, when the container 10 is transported to an area in which the recognizer 50 is located, the recognizer 50 recognizes the second identification code 220 on a side surface (that is, the specified surface) of the container 10 facing the recognizer, to determine the orientation of the container 10 based on the orientation corresponding to the orientation information of the second identification code 220 on the specified surface.

Specifically, after the orientation of the container is determined, a correspondence corresponding to the orientation may be obtained, and the position of each storage unit of the container may be further determined based on the correspondence corresponding to the orientation.

Step S3024: determining the position of each compartment of the container according to the second attribute of the container and the position of each storage unit.

Specifically, after the storage unit corresponding to each compartment of the container and the position of each storage unit of the container are determined, the position of each compartment of the container or a region in which each compartment is located may be determined.

Step S303: generating a sorting indication according to the position of each compartment.

Specifically, after the position of each compartment of the container is determined, the sorting indication may be generated based on the position of each compartment, so that the mechanical arm or the operator can learn the position of each compartment, thereby facilitating sorting of goods in a corresponding compartment.

Further, after the sorting indication is generated, the position of each compartment may be further displayed, to help the operator quickly and intuitively position a compartment that needs to be sorted.

In some embodiments, the sorting indication may be a light indication, and according to the position of each compartment and each compartment corresponding to a sorting task, light may be controlled to irradiate each compartment corresponding to the sorting task, to help the operator intuitively determine each compartment that needs to be sorted.

According to the container recognition method provided in this embodiment, by recognizing the second identification code arranged on the container, the position of each compartment of the container is determined, and the sorting indication is further generated based on the position of each compartment, to assist the operator or the mechanical arm in quickly positioning a selected compartment and further executing a corresponding sorting task, thereby improving the sorting efficiency.

FIG. 13 is a flowchart of a container recognition method according to another embodiment of the present disclosure. In this embodiment, step S302 and step S303 are described in further detail and related steps of performing verification on a target compartment are added after step S303 based on the embodiment shown in FIG. 10. As shown in FIG. 13, the container recognition method provided in this embodiment may include the following steps:

Step S401: obtaining a recognition result of a second identification code arranged on a specified surface of a container and a first attribute of the container.

The first attribute is used for describing a quantity of compartments corresponding to the container.

Specifically, when compartment division is performed on the container, the container is generally divided into a plurality of compartments having the same spatial size.

In some embodiments, each quantity of compartments may correspond to a unique and fixed division manner. After the quantity of compartments corresponding to the container, namely, a second attribute of the container is obtained, a storage unit corresponding to each compartment may be determined.

For example, an example in which the container opening is in a shape of a rectangle and the container corresponds to eight storage units including a storage unit A to a storage unit H is used, when the container is divided into two compartments, a separating plate may be inserted at separating openings corresponding central points of long sides of the container to equally divide the storage space of the container into two compartments, where one compartment corresponds to the storage units A, B, G, and H, and the other compartment corresponds to the storage units C, D, E, and F. When the container is divided into four compartments, a separating plate may only be inserted at separating openings corresponding to central points of sides of the rectangle in which the container opening is located, to equally divide the storage space of the container into four compartments, where each compartment corresponds to two storage units.

Step S402: determining a current pose of the container according to the recognition result.

Specifically, an orientation corresponding to the second identification code on the specified surface may be determined according to the recognition result, namely, an orientation of the container may be determined.

Step S403: determining a position of each compartment of the container according to the current pose of the container and the first attribute of the container.

Specifically, the quantity of the compartments of the container may correspond to a unique container division manner, so that the position of each compartment of the container or a region in which each compartment of the container is located may be determined based on the orientation of the container and the quantity of the compartments of the container.

Step S404: determining a position of a target compartment according to the position of each compartment and the target compartment corresponding to a sorting task.

In some embodiments, the sorting task may indicate a compartment that needs to be sorted, namely, the target compartment, and a sorted quantity of goods stored in each target compartment.

The target compartment corresponding to the sorting task is one or more compartments of the container.

In some embodiments, one or more target compartments corresponding to the sorting task may be determined according to the sorting task and storage information of each compartment of the container.

The storage information of each compartment includes goods and a quantity of the goods stored in the compartment.

Specifically, a task requirement of the sorting task may include only a type of goods that need to be sorted and a sorted quantity of goods of each type, so that as few compartments as possible may be allocated for the sorting task as the target compartment of the sorting task based on the task requirement of the sorting task and the storage information of each compartment of the container, thereby improving the sorting efficiency while meeting the task requirement of the sorting task.

Further, the position of each target compartment is determined based on compartment identification information of each target compartment corresponding to the sorting task and the determined position of each compartment.

Step S405: generating a control signal of an indication apparatus according to the position of the target compartment, to control the indication apparatus to indicate the target compartment corresponding to the sorting task.

In some embodiments, the indication apparatus may be a light indication apparatus that can emit light, to intuitively indicate the target compartment corresponding to the sorting task to the operator.

In some embodiments, the indication apparatus may be a laser indication apparatus such as a laser array that can emit a laser signal, to indicate the target compartment selected for the sorting task.

Specifically, control information of the indication apparatus may be generated according to the position of each target compartment, to control the indication apparatus to illuminate each target compartment corresponding to the sorting task simultaneously.

In some embodiments, one sorting task is performed by only one operator, so that after the position of each target compartment is determined, each control signal of the indication apparatus may be generated sequentially according to the position of each target compartment based on a set sequence, to control the indication apparatus to indicate the target compartment corresponding to the sorting task sequentially, that is, control the indication apparatus to indicate one target compartment every time.

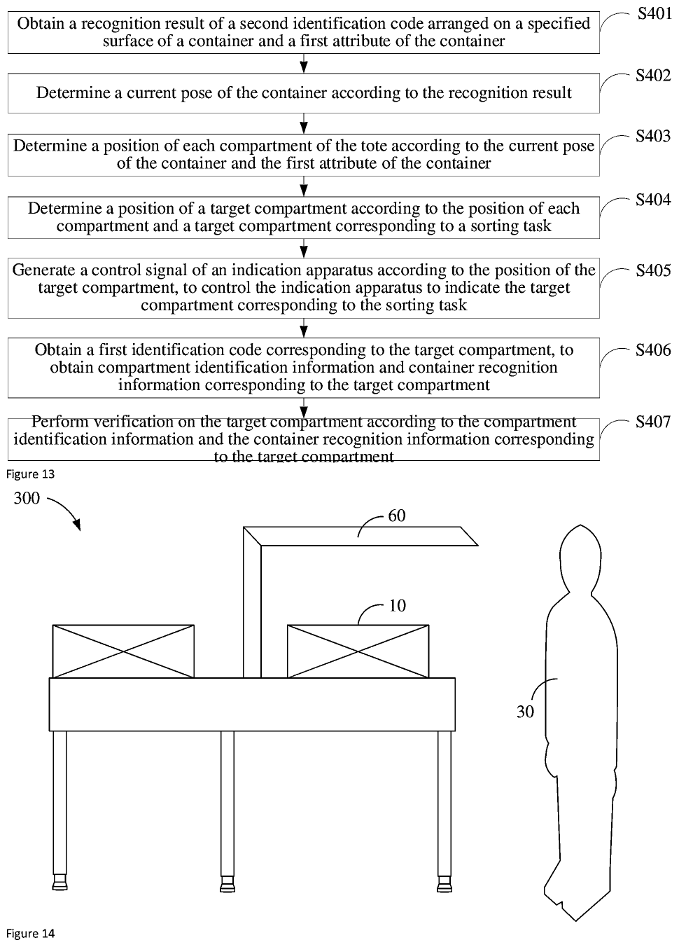

For example, FIG. 14 is a schematic structural diagram of a sorting workstation in the embodiment shown in FIG. 13 of the present disclosure. As shown in FIG. 14, when the container 10 is transported to the sorting workstation 300, the operator 30 can perform recognition and verification on each identification code arranged on the container 10 through a handheld recognizer. The indication apparatus 60 is arranged at the sorting workstation and located above the container 10, and the container recognition device may control the indication apparatus 60 to emit light according to the position of the target compartment, to illuminate the region in which the target compartment is located, so that the operator 30 can sort the goods stored in each target compartment sequentially based on the sorting task, to complete a corresponding sorting task.

Step S406: obtaining a first identification code corresponding to the target compartment, to obtain compartment identification information and container recognition information corresponding to the target compartment.

Step S407: performing verification on the target compartment according to the compartment identification information and the container recognition information corresponding to the target compartment.

Specifically, before the goods in the target compartment are sorted, the first identification code corresponding to the target compartment may be recognized through a recognizer such as a recognizer arranged at the sorting workstation or the handheld recognizer of the operator, and the first identification code corresponding to the target compartment is sent to the container recognition device, so that the container recognition device determines the compartment identification information and the container recognition information corresponding to the target compartment based on the recognized first identification code of the target compartment. Further, based on prestored container recognition information of the container and prestored compartment identification information of the target compartment of the container, verification is respectively performed on the obtained container recognition information and the obtained compartment identification information of the target compartment, to determine whether the target compartment is accurate, and if the target compartment is accurate, the operator or the mechanical arm is prompted to sort the goods in the target compartment. If the container recognition information or the compartment identification information of the target compartment is inconsistent, abnormality prompt information is generated to prompt the operator to check the container and the first identification code arranged on the compartment of the container, to determine an abnormality reason.

In this embodiment, the orientation of the container is determined by recognizing the second identification code arranged on the container, the position of each compartment of the container is further determined based on the quantity of the compartments of the container and the orientation of the container, to automatically determine the position of the target compartment corresponding to the sorting task, and the indication apparatus is controlled to indicate the target compartment corresponding to the sorting task, so that the operator or the mechanical arm can quickly and intuitively position the target compartment corresponding to the sorting task, thereby improving the sorting efficiency. In addition, before the sorting task of the target compartment is performed, verification may be further performed on the target compartment based on the first identification code arranged on the target compartment, to avoid that incorrect goods are sorted and a loss is caused to a user, thereby improving the processing accuracy of the sorting task.

FIG. 15 is a schematic structural diagram of a container recognition apparatus according to an embodiment of the present disclosure. As shown in FIG. 15, the apparatus includes a recognition module 1510, a position determining module 1520, and an instruction generation module 1530.

The recognition module 1510 is configured to recognize a second identification code arranged on a specified surface of a container, where the container is the container 10 according to any of the foregoing embodiments, and the specified surface is any surface of the container on which the second identification code is arranged. The position determining module 1520 is configured to determine a position of each compartment of the container according to a recognition result. The instruction generation module 1530 is configured to generate a sorting indication according to the position of each compartment.

Optionally, the position determining module 1520 is specifically configured to:
obtain a first attribute of the container, where the first attribute is used for describing a quantity of compartments corresponding to the container; determine a current pose of the container according to the recognition result; and determine the position of each compartment of the container according to the current pose of the container and the first attribute. Optionally, the position determining module 1520 is specifically configured to:
obtain a second attribute of the container, where the second attribute is used for describing a storage unit corresponding to each compartment of the container; determine a position of each storage unit of the container based on a first correspondence when orientation information of the container in the recognition result is first orientation information; or determine a position of each storage unit of the container based on a second correspondence when orientation information of the container in the recognition result is second orientation information; and determine the position of each compartment of the container according to the second attribute and the position of each storage unit, where the first correspondence is used for describing the position of each storage unit of the container when the container is under a first orientation or the orientation information is the first orientation information, and the second correspondence is used for describing the position of each storage unit of the container when the container is under a second orientation or the orientation information is the second orientation information.

Optionally, the apparatus further includes:
a target compartment determining module, configured to determine one or more target compartments according to a sorting task and storage information of each compartment of the container, where the storage information of each compartment includes goods and a quantity of the goods stored in the compartment.

Optionally, the apparatus further includes:
a target compartment verification module, configured to: obtain a first identification code corresponding to the target compartment, to obtain compartment identification information and container recognition information corresponding to the target compartment; and perform verification on the target compartment according to the compartment identification information and the container recognition information corresponding to the target compartment.

The container recognition apparatus provided in this embodiment of the present disclosure can perform the container recognition method provided in any embodiment of the present disclosure, and the corresponding functional modules for performing the method and beneficial effects thereof are provided.

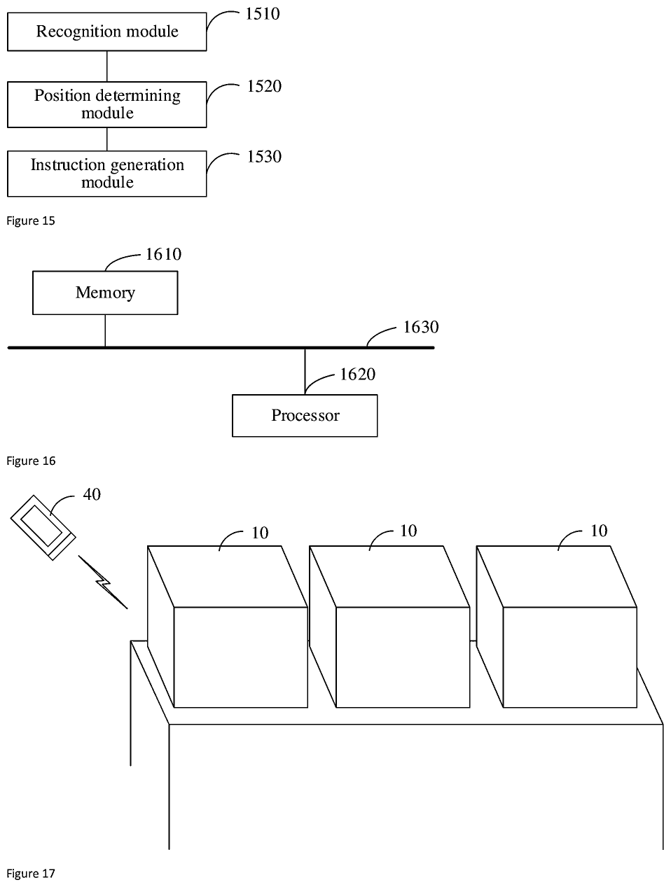

FIG. 16 is a schematic structural diagram of a container recognition device according to an embodiment of the present disclosure. As shown in FIG. 16, the container recognition device includes: a memory 1610, a processor 1620, and a computer program.

The computer program is stored in the memory 1610 and is executed by the processor 1620 to perform the container recognition method according to any one of the embodiments corresponding to FIG. 10, FIG. 11, and FIG. 13 of the present disclosure.

The memory 1610 is connected to the processor 1620 through a bus 1630.

For related description, reference may be made to the related description and effects corresponding to the steps in FIG. 10, FIG. 11, and FIG. 13 for understanding, and details are not described herein again.

FIG. 17 is a schematic structural diagram of a warehousing system according to an embodiment of the present disclosure. As shown in FIG. 17, the warehousing system includes: a container 10 and a container recognition device 40.

The container recognition device 40 is the container recognition device provided in the embodiment shown in FIG. 14 of the present disclosure.

The warehousing system may store or process a plurality of containers 10, and FIG. 17 is described by using three containers 10 as an example. The container 10 may be stored on an apparatus such as a work table or a rack.

In some embodiments, the warehousing system further includes apparatuses such as a robot, a conveyor, a storage rack, a work table, an unloading machine, and a lifting machine

An embodiment of the present disclosure provides a computer-readable storage medium, having a computer program stored therein, where when the computer program is executed by a processor, the container recognition method according to any one of the embodiments corresponding to FIG. 10, FIG. 11, and FIG. 13 of the present disclosure is performed.

For example, the computer-readable storage medium may be a ROM, a random access memory (RAM), a CD-ROM, a magnetic tape, a floppy disk, or an optical data storage device and etc.

The present disclosure further provides a program product, including an executable computer program, the executable computer program being stored in a readable storage medium. At least one processor of a container recognition device or a warehousing system can read the computer program from the readable storage medium, and the at least one processor executes the computer program, to cause a container recognition apparatus to perform the container recognition method provided in the foregoing implementations.

In the several embodiments provided in the present disclosure, it should be understood that the disclosed device and method may be implemented in other manners. For example, the described device embodiments are merely an example. For example, the module division is merely logical function division and there may be another division manner during actual implementation. For example, a plurality of modules may be combined or integrated into another system, or some features may be ignored or not performed. In addition, the displayed or discussed mutual couplings or direct couplings or communication connections may be implemented by using some interfaces. The indirect couplings or communication connections between the apparatuses or modules may be implemented in electronic, mechanical, or other forms.

The modules described as separate components may or may not be physically separated, and the components displayed as modules may or may not be physical units, namely, may be located in one place or may be distributed over a plurality of network units. Some or all of the modules may be selected according to an actual requirement to implement the objectives of the solutions of the embodiments.

In addition, functional modules in the embodiments of the present disclosure may be integrated into one processing unit, or each of the modules may exist alone physically, or two or more modules are integrated into one unit. The integrated unit may be implemented in a form of hardware, or may be implemented in a form of hardware plus a software functional unit.

When the foregoing integrated unit is implemented in a form of a software functional module, the integrated unit may be stored in a computer-readable storage medium. The software functional module is stored in a storage medium and includes several instructions for instructing a computer device (which may be a personal computer, a server, or a network device) or a processor to perform some of the steps of the methods described in the embodiments of the present disclosure.

It should be understood that, the processor may be a central processing unit (Central Processing Unit, short for CPU), or another general-purpose processor, a digital signal processor (Digital Signal Processor, short for DSP), an application-specific integrated circuit (Application Specific Integrated Circuit, short for ASIC), or the like. The general-purpose processor may be a microprocessor, or the processor may be any conventional processor and the like. Steps of the methods disclosed with reference to the present disclosure may be directly performed and completed by a hardware processor, or may be performed and completed by using a combination of hardware and a software module in the processor.

The memory may include a high-speed RAM memory, and may further include a non-volatile memory NVM, for example, at least one magnetic disk memory. The memory may alternatively be a USB flash drive, a removable hard disk, a read-only memory, a magnetic disk, or an optical disc.

The bus may be an industry standard architecture (Industry Standard Architecture, short for ISA) bus, a peripheral component interconnect (Peripheral Component, short for PCI) bus, an extended industry standard architecture (Extended Industry Standard Architecture, short for EISA) bus, or the like. The bus may be classified into an address bus, a data bus, a control bus, or the like. For ease of representation, the bus in the accompanying drawings of the present disclosure does not indicate that there is only one bus or only one type of bus.

The storage medium may be implemented by any type of volatile or non-volatile storage devices or a combination thereof, such as a static random access memory (SRAM), an electrically erasable programmable read-only memory (EPROM), an erasable programmable read-only memory (EPROM), a programmable read-only memory (PROM), a read-only memory (ROM), a magnetic memory, a flash memory, a magnetic disc, or an optical disc. The storage medium may be any available medium accessible to a general-purpose or dedicated computer.

For example, a storage medium is coupled to a processor, so that the processor can read information from the storage medium or write information into the storage medium. Certainly, the storage medium may be a component of the processor. The processor and the storage medium may be located in an application-specific integrated circuit (Application Specific Integrated Circuits, short for ASIC). Certainly, the processor and the storage medium may alternatively exist in an electronic device or a main controller as discrete components.

A person of ordinary skill in the art may understand that all or some of the steps of the method embodiments may be implemented by a program instructing relevant hardware. The program may be stored in a computer-readable storage medium. When the program is executed, steps of the method embodiments are performed. The foregoing storage medium includes: a medium such as a ROM, a RAM, a magnetic disc, or an optical disc that can store program code and etc.

Finally, it should be noted that the foregoing embodiments are merely used for describing the technical solutions of the present disclosure, but are not intended to limit the present disclosure. Although the present disclosure is described in detail with reference to the foregoing embodiments, a person of ordinary skill in the art should understand that, modifications may still be made to the technical solutions in the foregoing embodiments, or equivalent replacements may be made to some or all of the technical features; and these modifications or replacements will not cause the essence of corresponding technical solutions to depart from the scope of the technical solutions in the embodiments of the present disclosure.

1. A container, comprising:
a base plate;
a side plate, wherein the base plate and the side plate form a compartment; and
a container identification code attached to the side plate, wherein the container identification code comprises a first identification code and a second identification code, the first identification code is used for identifying the compartment of the container, and the second identification code is used for identifying an orientation of the container, wherein
the compartment is an independent space used for storing goods in the container, the compartment comprises one or more storage units, and the storage unit is a minimum unit used for storing goods dividable by the container.

2. The container according to claim 1, wherein the base plate and the side plate form at least two compartments, and the first identification code for identifying each of the at least two compartments is located on the side plate.

3. The container according to claim 2, wherein there is at least one first identification code for identifying each of the at least two compartments.

4. The container according to claim 1, wherein the first identification code or the second identification code is further used for identifying the container.

5. The container according to claim 1, wherein a quantity of first identification codes is a quantity of storage units in the container.

6. The container according to claim 1, wherein a container opening configured for retrieving and storing goods is provided on the container, at least one first side of each compartment overlaps with at least part of a side of the container opening, the first identification code is arranged on at least two sides of the container opening, and the first identification code is mapped to a compartment to which a first side on which the first identification code is located belongs.

7. The container according to claim 6, wherein the first identification code is arranged on two opposite second sides of the container opening, wherein each compartment has one side intersecting with one of the second sides.

8. The container according to claim 1, wherein the base plate and the side plate form an inner cavity and a container opening;
the first identification code comprises a first part, a second part, and a third part; and
the first part of the first identification code is arranged on a surface of the side plate facing away from the inner cavity, the second part is arranged at a top of the side plate, and the third part is arranged on a surface of the side plate facing the inner cavity.

9. The container according to claim 8, wherein a text code is arranged on the first part and the third part; and
when the first identification code is unfolded, the text code arranged on the first part and the text code arranged on the third part of the first identification code are symmetrical about a center of the first identification code.

10. The container according to claim 1, wherein separating openings are provided on at least two opposite side surfaces of the container, and when a separating plate is inserted into the separating openings provided opposite to each other, a storage space of the container is separated to obtain a plurality of compartments.

11. The container according to claim 10, wherein a first quantity of separating openings are respectively provided on a first side surface and a second side surface of the container, a second quantity of separating openings are respectively provided on a third side surface and a fourth side surface of the container, the first side surface is opposite to the second side surface, the third side surface is opposite to the fourth side surface, and the first quantity is less than or equal to the second quantity.

12. The container according to claim 1, wherein the second identification code is arranged on at least two side surfaces of the container.

13. The container according to claim 12, wherein each side surface of the container is provided with one second identification code, and the second identification code on a first side surface is arranged opposite to the second identification code on a second side surface; and
an arrangement position of the second identification code on a third side surface and an arrangement position of the second identification code on a fourth side surface are symmetrical about a center point of the container.

14. The container according to claim 12, wherein second identification codes arranged on the two opposite side surfaces of the container corresponds to the opposite orientations of the container.

15. The container according to claim 1, further comprising a third identification code, wherein the third identification code comprises a preset identification pattern, and a robot is configured to determine a pose relationship between the robot and the container on which the third identification code is arranged by recognizing the preset identification pattern of the third identification code.

16. A container recognition method, comprising:
obtaining a recognition result of a second identification code arranged on a specified surface of a container, wherein the container is the container according to claim 1, and the specified surface is any surface of the container on which the second identification code is arranged;
determining a position of each compartment of the container according to the recognition result; and
generating a sorting indication according to the position of each compartment.

17. The method according to claim 16, wherein the determining the position of each compartment of the container according to the recognition result comprises:
obtaining a first attribute of the container, wherein the first attribute is used for describing a quantity of compartments corresponding to the container;
determining a current pose of the container according to the recognition result; and
determining the position of each compartment of the container according to the current pose of the container and the first attribute of the container.

18. The method according to claim 16, wherein the determining the position of each compartment of the container according to the recognition result comprises:
obtaining a second attribute of the container, wherein the second attribute is used for describing a storage unit corresponding to each compartment of the container;
determining a position of each storage unit of the container based on a first correspondence when orientation information of the container in the recognition result is first orientation information; or
determining a position of each storage unit of the container based on a second correspondence when orientation information of the container in the recognition result is second orientation information; and
determining the position of each compartment of the container according to the second attribute of the container and the position of each storage unit, wherein
the first correspondence is used for describing the position of each storage unit of the container when the container is under a first orientation or the orientation information is the first orientation information, and the second correspondence is used for describing the position of each storage unit of the container when the container is under a second orientation or the orientation information is the second orientation information.

19. The method according to claim 16, wherein the generating the sorting indication according to the position of each compartment comprises:
determining a position of a target compartment according to the position of each compartment and the target compartment corresponding to a sorting task, wherein the target compartment corresponding to the sorting task is one or more compartments of the container; and
generating a control signal of an indication apparatus according to the position of the target compartment, to control the indication apparatus to indicate the target compartment corresponding to the sorting task.

20. The method according to claim 19, further comprising:
determining one or more target compartments according to the sorting task and storage information of each compartment of the container, wherein the storage information of each compartment comprises goods and a quantity of the goods stored in the compartment.
